(19) United States
(12) Patent Application Publication
(10) Pub. No.: US 2022/0222130 A1
(43) Pub. Date: Jul. 14, 2022

(54) SYSTEMS AND METHODS FOR INTEGRATING CONTENT MANAGEMENT SYSTEMS WITH SOFTWARE

(71) Applicant: Bit Gooey Inc., Salt Lake City, UT (US)

(72) Inventor: Christopher Alexander Burns, Salt Lake city, UT (US)

(21) Appl. No.: 17/148,956

(22) Filed: Jan. 14, 2021

(51) Int. Cl. G06F 9/54; G06F 16/955

(52) U.S. Cl. CPC G06F 9/541; G06Q 10/0639; G06F 16/9566

(57) ABSTRACT

A system for facilitating the integration between a content management system (CMS) and software, such as productivity analyzer software. A company may use the system to isolate the CMS and the software from each other while integrating the functionality of both the CMS and the software to a compatible interface. The CMS and the software may interface with an adapter, avoiding the need for the CMS or the software to use each other's interfaces directly. The system may allow the CMS and the software to function unmodified as decoupled system components. If the CMS and software are able to function as decoupled system components, they may be more easily upgraded, altered, or replaced.

### TECHNICAL FIELD

The present disclosure is related to systems and methods for integrating a content management system (CMS) with software, and more particularly to systems and methods for integrating a CMS with productivity analysis software and other software not integrated into the CMS.

### BACKGROUND

Companies are increasingly using websites to conduct at least a portion of their business online. Many of these websites are built using self-hosted solutions that enable the business to create and manage all of their content on a website, which are commonly referred to as content management systems (CMSs). These websites commonly need to be upgraded, altered, or replaced. However, upgrading, altering, or replacing a website may be expensive. For example, updating, altering, or replacing functions of the website with traditional software otherwise used by the company that is not integrated into the CMS may face difficulties. Such changes may require substantial modifications to either the website or the traditional software products. These substantial modifications may require a great deal of costly software engineering and resources. Accordingly, improvements in website management techniques are needed.

### SUMMARY

Methods and systems are disclosed for facilitating the integration of a CMS with software, such as productivity analysis software. A system may include a first server and a second server, which may be the same server. The first server may include a CMS configured to power a website, and the second server may include a software program, such as a productivity analyzer software. An adapter may be configured between the CMS and the software program. The adapter may include a first interface associated with the CMS and a second interface associated with the software program. The first interface may be configured to isolate the software program from modifications associated with the CMS and the second interface may be configured to render content associated with the software program into at least one template associated with the CMS. At least one user may access the at least one template via a universal resource locator (URL) associated with the website.

### BRIEF DESCRIPTION OF DRAWINGS

The accompanying drawings, which are incorporated in and constitute a part of this specification, illustrate embodiments and together with the description, serve to explain the principles of the methods and systems:

FIG. 1 illustrates a block diagram of an example system according to an embodiment of the present disclosure;

FIG. 2. illustrates an example view of a CMS template according to an embodiment of the present disclosure; and

FIG. 3 illustrates an example computing device according to an embodiment of the present disclosure.

### DETAILED DESCRIPTION

A company may utilize traditional software, such as productivity analysis software. If a company utilizes productivity analysis software, the software may facilitate the tracking and analysis of productivity associated with the company, such as the productivity of the company's workforce. It may be advantageous for a company that utilizes traditional software to transition these traditional software products to web-based software products and services, such as those facilitated by content management systems (CMS). A CMS is software that may be used to manage the creation and modification of digital content. For example, CMSs may be used to manage enterprise content or web content. Commonly used CMSs include WordPress, Drupal, Joomla, and Magento. However, a company that wants to transition traditional software to web-based software products facilitated by a CMS may face difficulties. For example, such a transition may require substantial modifications to either the website CMS or to the company's traditional software. Such modifications may be expensive, as they may require software engineering expertise or other costly resources.

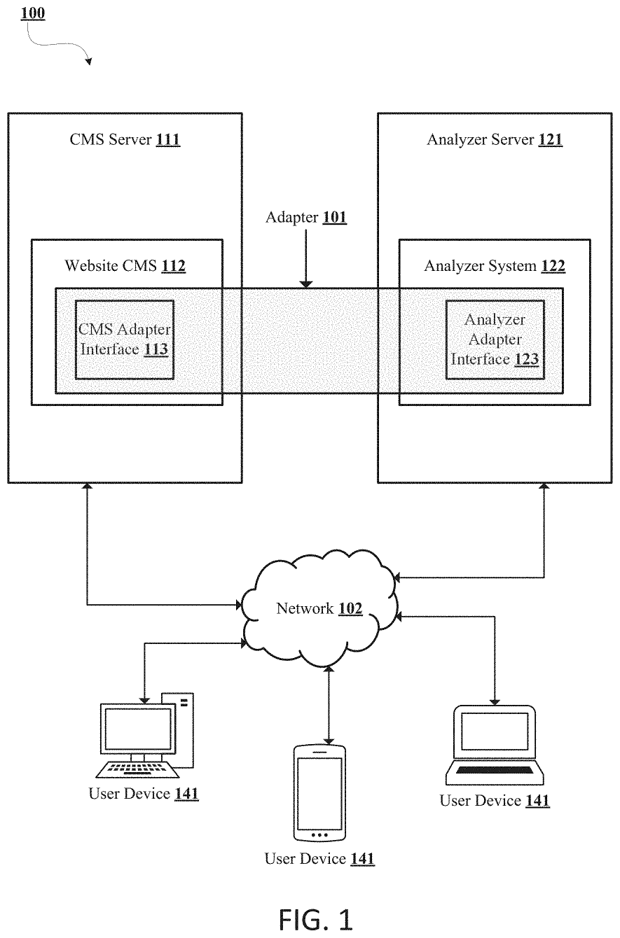

A company may want to update or replace its website while avoiding these difficulties. FIG. 1 illustrates an exemplary system 100 for integrating a CMS with software, such as productivity analyzer software. The system 100 may allow a company to avoid the cost prohibitive difficulties associated with website updating or replacement by providing an adapter that is configured to integrate CMS with software, such as productivity analyzer software. The adapter may include a first slot for an interface associated with the CMS side of the adapter and another slot for an interface associated with the software side of the adapter. By including two different slots for the two different interfaces, the adapter decouples the CMS and the software systems, allowing each to operate with minimal modification. When a company needs to update or replace its website, rather than modifying the CMS or software system, the adapter may perform conditioning of inputs and outputs between the different interfaces. Thus, use of the system 100 may allow a company that would otherwise face difficulties in updating or replacing its website to design new templates, upgrade its website, replace the CMS, or upgrade the software, such as the productivity analyzer software, by simply substituting in or creating a purpose-built-interface into an appropriate slot of the adapter module.

The system 100 includes a CMS server 111, an analyzer server 121, an adapter 101, and at least one user device 141. The at least one user device 141, the CMS server 111, and the analyzer server 121 may be in communication via a network 102. The network 102 may comprise one or more public networks (e.g., the Internet) and/or one or more private networks. A private network may include a wireless local area network (WLAN), a local area network (LAN), a wide area network (WAN), a cellular network, or an intranet. The network 118 may comprise wired network(s) and/or wireless network(s).

The CMS server 111 may include a server or a cluster of servers housing a website CMS, such as the website CMS 112. The website CMS 112 may include a CMS that powers a website. For example, the CMS may be WordPress, Drupal, Joomla, and Magento. The website may be a website associated with a business. The analyzer server 121 may include a server or a cluster of servers housing an analyzer system 122 or some other type of software. In an embodiment, the analyzer server 121 includes the same server or cluster of servers that house the website CMS 112. The analyzer system 122 may include software, such as productivity analyzer software or other software that is not integrated into the CMS. The CMS server 111 and the analyzer server 121 may be associated with a business entity seeking to update or replace its website or functions of the website, such as the companies described above.

The adapter 101 may be an adapter module that integrates a CMS and software by providing a compatible interface for both the CMS and the software to utilize. For example, the adapter 101 may use a module loaded by a CMS to provide an interface for the content associated with the software to be embedded within the CMS content templates sent to web browsers associated with end users. The adapter may isolate the CMS and the software from each other while integrating the functionality of both the CMS and the software to the compatible interface. The CMS and the software may interface with the adapter 101. The CMS and the software may not need to use each other's interfaces directly if they are interfaced with the adapter 101. Accordingly, the CMS and software may function unmodified as decoupled system components, and if either the CMS or software need to be upgraded, replaced, or altered, the adapter 101 may facilitate such upgrade, replacement or alteration.

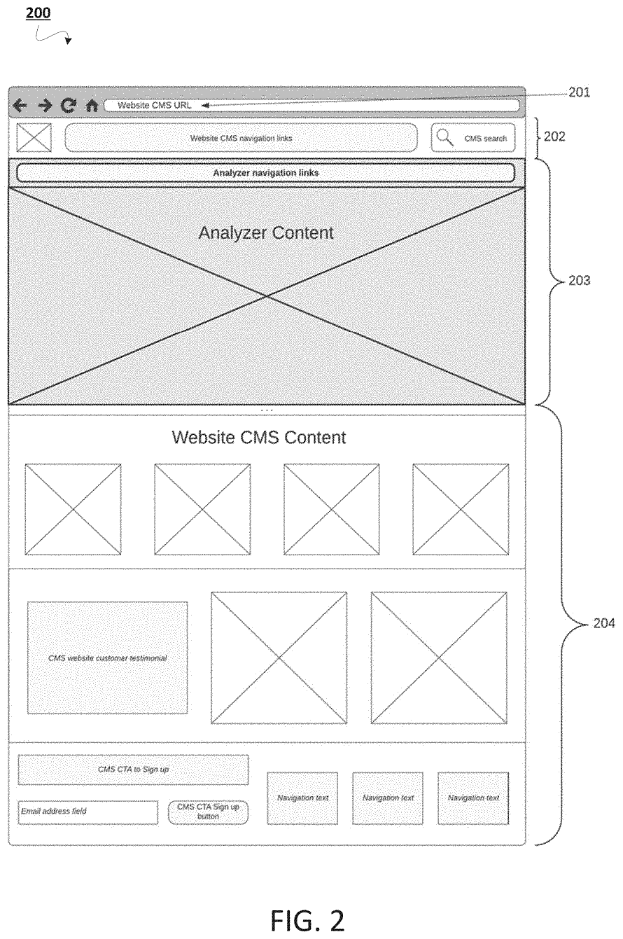

In an embodiment, the adapter 101 may be between a website CMS, such as the website CMS 112 and an analyzer system, such as the analyzer system 122. The adapter 101 may provide an interface configured to allow the website CMS to embed content, such as interactive content, from the analyzer system into its responses to website visitors. The website may be a website powered by the CMS. For example, if a user visits the website, the user may be able to view the content associated with the productivity analyzer system, with which the user may already be familiar, rendered within the website CMS template. An exemplary website CMS template 200 is illustrated in FIG. 2, discussed below.

The adapter 101 may include a dual interface module that connects a website CMS and a productivity analyzer system. The adapter 101 may treat the website CMS 112 and the analyzer system 122 as decoupled components. For example, the adapter 101 may include a first adapter interface, such as a CMS adapter interface 113, and a second adapter interface, such as an analyzer adapter interface 123. The CMS adapter interface 113 may be the side of the adapter's 101 dual interface that resides in the CMS server 111, such as within the website CMS 112. The CMS adapter interface 113 may be configured to isolate the analyzer system 122 from changes in the website CMS. The analyzer adapter interface 123 may be the side of the adapter's 101 dual interface that resides in the analyzer server 121, such as within the analyzer system 122. The analyzer adapter interface 123 may be used by the analyzer system 122 to render content associated with the analyzer system 122 into website CMS 112 templates, such as the template 200 of FIG. 2, discussed below.

One or more users, such as customers of the analyzer system 122, may access content associated with the analyzer system 122 via the one or more user devices 141. The users may access content associated with the analyzer system 122 using a web browser, such as Google CHROME, SAFARI, FIREFOX, or INTERNET EXPLORER, on the one or more user devices 141. The one or more users may access content associated with the analyzer system 122 through the website CMS 112. The user devices 141 may be comprise any of a variety of different types of wireless devices, including for example, a smartphone, a tablet computer, a laptop computer, a notebook computer, a personal computer, other consumer electronics, and the like.

FIG. 2 depicts an exemplary website CMS template 200. The website CMS template 200 may include content associated with a system, such as the analyzer system 122. The website CMS template 200 may depict a customer's view of the content associated with the system, such as the analyzer system 122, when rendered inside the website CMS template 200. For example, one or more customers may view the CMS template 200 on one or more user devices, such as the user devices 141 of FIG. 1, via a web browser.

The CMS template 200 may include a uniform resource locator (URL), such as the website CMS URL 201. The URL may be the URL at which a customer may view templates rendered with content associated with the system, such as the analyzer system 122. The CMS template 200 may include a navigation bar 202. The navigation bar 202 may remain intact and may be rendered normally. The CMS template 200 may include rendered content 203 associated with the system, such as the analyzer system 122. The content 203 may be rendered directly into the website CMS 112 using the adapter 101. For example, the content 203 may be rendered directly into the website CMS 112 using the analyzer adapter interface 123 of the analyzer 101. The CMS template 200 may include additional website content 204. The additional website content (not shown), as well as a footer (not shown) associated with the website, may be rendered as normal.

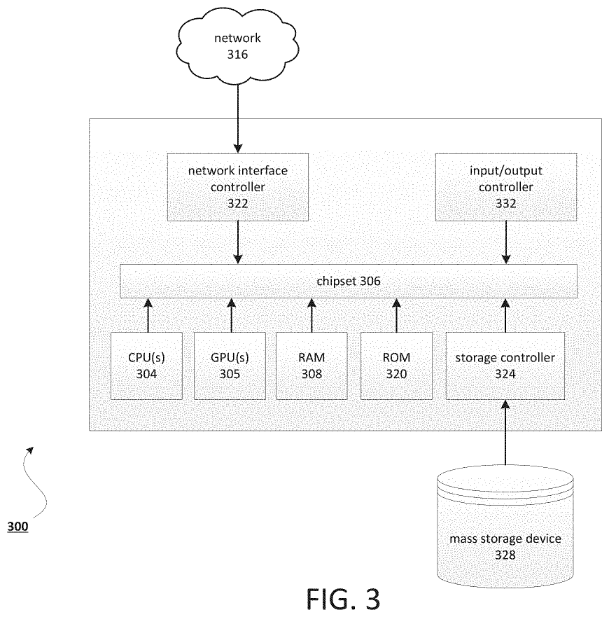

FIG. 3 depicts a computing device that may be used in various aspects. With regard to the example system of FIG. 1, one or more of the subscription billing system 101, the at least one user device 125, and the website 131 may be implemented in an instance of a computing device 300 of FIG. 3. The computer architecture shown in FIG. 3 shows a conventional server computer, workstation, desktop computer, laptop, tablet, network appliance, PDA, e-reader, digital cellular phone, or other computing node, and may be utilized to execute any aspects of the computers described herein.

The computing device 300 may include a baseboard, or “motherboard,” which is a printed circuit board to which a multitude of components or devices may be connected by way of a system bus or other electrical communication paths. One or more central processing units (CPUs) 304 may operate in conjunction with a chipset 306. The CPU(s) 304 may be standard programmable processors that perform arithmetic and logical operations necessary for the operation of the computing device 300.

The CPU(s) 304 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 304 may be augmented with or replaced by other processing units, such as GPU(s) 305. The GPU(s) 305 may comprise processing units specialized for but not necessarily limited to highly parallel computations, such as graphics and other visualization-related processing.

A user interface may be provided between the CPU(s) 304 and the remainder of the components and devices on the baseboard. The interface may be used to access a random access memory (RAM) 308 used as the main memory in the computing device 300. The interface may be used to access a computer-readable storage medium, such as a read-only memory (ROM) 320 or non-volatile RAM (NVRAM) (not shown), for storing basic routines that may help to start up the computing device 300 and to transfer information between the various components and devices. ROM 320 or NVRAM may also store other software components necessary for the operation of the computing device 300 in accordance with the aspects described herein. The user interface may be provided by a one or more electrical components such as the chipset 306.

The computing device 300 may operate in a networked environment using logical connections to remote computing nodes and computer systems through local area network (LAN) 316. The chipset 306 may include functionality for providing network connectivity through a network interface controller (NIC) 322, such as a gigabit Ethernet adapter. A NIC 322 may be capable of connecting the computing device 300 to other computing nodes over a network 316. It should be appreciated that multiple NICs 322 may be present in the computing device 300, connecting the computing device to other types of networks and remote computer systems.

The computing device 300 may be connected to a storage device 328 that provides non-volatile storage for the computer. The storage device 328 may store system programs, application programs, other program modules, and data, which have been described in greater detail herein. The storage device 328 may be connected to the computing device 300 through a storage controller 324 connected to the chipset 306. The storage device 328 may consist of one or more physical storage units. A storage controller 324 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 300 may store data on a storage device 328 by transforming the physical state of the physical storage units to reflect the information being stored. The specific transformation of a physical state may depend on various factors and on different implementations of this description. Examples of such factors may include, but are not limited to, the technology used to implement the physical storage units and whether the storage device 328 is characterized as primary or secondary storage and the like.

For example, the computing device 300 may store information to the storage device 328 by issuing instructions through a storage controller 324 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 300 may read information from the storage device 328 by detecting the physical states or characteristics of one or more particular locations within the physical storage units.

In addition or alternatively to the storage device 328 described herein, the computing device 300 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 300.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A storage device, such as the storage device 328 depicted in FIG. 3, may store an operating system utilized to control the operation of the computing device 300. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The storage device 328 may store other system or application programs and data utilized by the computing device 300.

The storage device 328 or other computer-readable storage media may also be encoded with computer-executable instructions, which, when loaded into the computing device 300, transforms the computing device from a general-purpose computing system into a special-purpose computer capable of implementing the aspects described herein. These computer-executable instructions transform the computing device 300 by specifying how the CPU(s) 304 transition between states, as described herein. The computing device 300 may have access to computer-readable storage media storing computer-executable instructions, which, when executed by the computing device 300, may perform any methods described herein.

A computing device, such as the computing device 300 depicted in FIG. 3, may also include an input/output controller 332 for receiving and processing input from a number of input devices, such as a keyboard, a mouse, a touchpad, a touch screen, an electronic stylus, or other type of input device. Similarly, an input/output controller 332 may provide output to a display, such as a computer monitor, a flat-panel display, a digital projector, a printer, a plotter, or other type of output device. It will be appreciated that the computing device 300 may not include all of the components shown in FIG. 3, may include other components that are not explicitly shown in FIG. 3, or may utilize an architecture completely different than that shown in FIG. 3.

As described herein, a computing device may be a physical computing device, such as the computing device 300 of FIG. 3. A computing node may also include a virtual machine host process and one or more virtual machine instances. Computer-executable instructions may be executed by the physical hardware of a computing device indirectly through interpretation and/or execution of instructions stored and executed in the context of a virtual machine.

One skilled in the art will appreciate that the systems and methods disclosed herein may be implemented via a computing device that may comprise, but are not limited to, one or more processors, a system memory, and a system bus that couples various system components including the processor to the system memory. In the case of multiple processors, the system may utilize parallel computing.

For purposes of illustration, application programs and other executable program components such as the operating system are illustrated herein as discrete blocks, although it is recognized that such programs and components reside at various times in different storage components of the computing device, and are executed by the data processor(s) of the computer. An implementation of service software may be stored on or transmitted across some form of computer- readable media. Any of the disclosed methods may be performed by computer-readable instructions embodied on computer-readable media. Computer-readable media may be any available media that may be accessed by a computer. By way of example and not meant to be limiting, computer-readable media may comprise “computer storage media” and “communications media.” “Computer storage media” comprise volatile and non-volatile, removable and non-removable media implemented in any methods or technology for storage of information such as computer-readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer. Application programs and the like and/or storage media may be implemented, at least in part, at a remote system.

As used in the specification and the appended claims, the singular forms “a,” “an” and “the” include plural referents unless the context clearly dictates otherwise. Ranges may be expressed herein as from “about” one particular value, and/or to “about” another particular value. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A system for integrating a content management system (CMS) with independent software, the system comprising:
a first server including a CMS configured to power a website;
a second server including the independent software, the independent software including productivity analyzer software; and
an adapter configured between the CMS and the productivity analyzer software, wherein the adapter includes a first interface associated with the CMS and a second interface associated with the productivity analyzer software, wherein the first interface is configured to isolate the productivity analyzer software from modifications associated with the CMS and the second interface is configured to render content associated with the productivity analyzer software into at least one template associated with the CMS.

2. The system of claim 1, wherein the CMS is one or more of WordPress, Drupal, Joomla, and Magento.

3. The system of claim 1, wherein at least one user may access the at least one template via a universal resource locator (URL) associated with the website.

4. The system of claim 1, wherein the second interface is configured to render content associated with the productivity analyzer software into the at least one template associated with the CMS using the first interface.

5. The system of claim 1, wherein the adapter is configured to treat the CMS and the productivity analyzer software as decoupled components.

6. The system of claim 1, wherein the adapter is configured to perform conditioning of inputs and outputs between the first interface and the second interface.

7. The system of claim 1, wherein the first server and the second server at the same server.

8. The system of claim 1, wherein the first server and the second server are different servers.

9. A system for integrating a content management system (CMS) with software, the system comprising:
a first server including a CMS configured to power a website;
a second server including a software program; and
an adapter configured between the CMS and the software program, wherein the adapter includes a first interface associated with the CMS and a second interface associated with the software program, wherein the adapter is configured to de-couple the CMS and the software program.

10. The system of claim 9, wherein the first interface is configured to isolate the software program from modifications associated with the CMS.

11. The system of claim 9, wherein the second interface is configured to render content associated with the software program into at least one template associated with the CMS.

12. The system of claim 11, wherein at least one user may access the at least one template via a universal resource locator (URL) associated with the website.

13. The system of claim 11, wherein the second interface is configured to render content associated with the software program into the at least one template associated with the CMS using the first interface.

14. The system of claim 9, wherein the adapter is configured to perform conditioning of inputs and outputs between the first interface and the second interface.

15. The system of claim 9, wherein the CMS is one or more of WordPress, Drupal, Joomla, and Magento.

16. The system of claim 9, wherein the first server and the second server at the same server.

17. The system of claim 9, wherein the first server and the second server are different servers.

18. A system for integrating a content management system (CMS) with software, the system comprising:
a server including a CMS configured to power a website and a software program; and
an adapter configured between the CMS and the software program, wherein the adapter includes a first interface associated with the CMS and a second interface associated with the software program, wherein the adapter is configured to de-couple the CMS and the software program.

19. The system of claim 18, wherein the first interface is configured to isolate the software program from modifications associated with the CMS.

20. The system of claim 18, wherein the second interface is configured to render content associated with the software program into at least one template associated with the CMS.

21. The system of claim 18, wherein at least one user may access the at least one template via a universal resource locator (URL) associated with the website.

22. The system of claim 18, wherein the second interface is configured to render content associated with the software program into the at least one template associated with the CMS using the first interface.

23. The system of claim 18, wherein the adapter is configured to perform conditioning of inputs and outputs between the first interface and the second interface.

24. The system of claim 18, wherein the CMS is one or more of WordPress, Drupal, Joomla, and Magento.
